(19) United States
(12) Patent Application Publication
(10) Pub. No.: US 2024/0095648 A1
(43) Pub. Date: Mar. 21, 2024

(54) RAIL RAKE PLANNING FOR TRANSPORTATION AND MAINTENANCE

(71) Applicant: SAP SE, Walldorf (DE)

(72) Inventors: Somjit Bhowmick, Kolkata (IN); Anirudh Saraiya, Bhopal (IN); Srinivasan Ramanathan, Bangalore (IN)

(21) Appl. No.: 17/898,843

(22) Filed: Aug. 30, 2022

(51) Int. Cl. G06Q 10/08; G06Q 10/06

(52) U.S. Cl. CPC G06Q 10/083; G06Q 10/06311; G06Q 10/0633

(57) ABSTRACT

Given a set of port stations, a collection of forwarding orders to/from the port stations, and a set of available rail rakes along with their current schedules, a rake plan that maps order containers to rakes is generated. The optimization model is constrained by rake availability, rake capacity (the number of containers that can be accommodated by a rake), and the indivisibility of containers. The scheduling of the rail rakes can be represented as a sparse 3-dimensional binary matrix. Each element of the matrix indicates whether a particular rail rake is assigned to carry a particular container from a particular order in the next trip. The rail rake scheduling data can be used to generate communications from a rail rake planning server to multiple client devices, each client device associated with a different port station.

### TECHNICAL FIELD

The subject matter disclosed herein generally relates to planning rail rakes and containers.

### BACKGROUND

A rail planner manually uses different data sources to allocate containers and plan rakes between different source and destination stations.

### BRIEF DESCRIPTION OF THE DRAWINGS

FIG. 1 is a network diagram illustrating an example network environment suitable for rail rake planning for transportation and maintenance.

FIG. 2 is a block diagram of an example rail rake scheduling server suitable for rail rake planning.

FIGS. 3-6 are block diagrams of an example database schema, suitable for use in rail rake planning.

FIG. 7 is a flowchart illustrating operations of an example method suitable for rail rake planning for transportation and maintenance.

FIG. 8 is a block diagram showing one example of a software architecture for a computing device.

FIG. 9 is a block diagram of a machine in the example form of a computer system within which instructions may be executed for causing the machine to perform any one or more of the methodologies discussed herein.

### DETAILED DESCRIPTION

Example methods and systems are directed to rail rake planning for transportation and maintenance. Existing systems allow human planners to select the allocation of rail rakes to transport containers to service orders and to receive planned maintenance. Using automated systems described herein, the efficiency of the allocation of rail rakes is improved, resulting in improved cash flow from order servicing, improved utilization of rail rakes, or any suitable combination thereof.

A database stores records regarding a set of port stations. Each port station is a shipping yard accessible to freight trains. The database also stores records regarding forwarding orders. Each forwarding order identifies a number of shipping containers to be transported from an origin port station to a destination port station. Based on the data accessed from the database, an automated system determines an allocation of rail rakes among the forwarding orders.

For a given input dataset, many allocations of rail rakes to orders are possible. To select a particular allocation, an optimization model is used. The optimization model is constrained by rake availability, rake capacity (the number of containers that can be accommodated by a rake), and the indivisibility of containers. Additionally, rail rakes may have scheduled maintenance that is to be performed at a home port station for the rail rake after a predetermined distance has been traveled by the rail rake, after a predetermined period of time since the last maintenance, or any suitable combination thereof.

The planning of the rail rakes can be represented as a sparse 3-dimensional binary matrix. Each element of the matrix indicates whether a particular rail rake is assigned to carry a particular container from a particular order in the next trip. Thus the matrix will have a single ‘1’ for each container being carried in the next trip but will contain a number of elements equal to the number of rakes times the number of orders times the maximum number of containers in the set of orders. The remaining elements will have ‘0’ values, indicating that the (rake, order, container) triple is not included in the next trip.

The rail rake scheduling data can be used to generate communications from a rail rake planning server to multiple client devices, each client device associated with a different port station. For example, emails may be sent to the port station managers to inform them of the containers to be loaded on the rail rakes at their port station and the destination port station that the rail rakes are to be sent to. In this way, the rail rake planning can be implemented by the port station managers in accordance with the planning performed by the rail rake planning server.

When these effects are considered in aggregate, one or more of the methodologies described herein may obviate a need for certain efforts or resources that otherwise would be involved in rail rake planning. Computing resources used by one or more machines, databases, or networks may similarly be reduced. Examples of such computing resources include processor cycles, network traffic, memory usage, data storage capacity, power consumption, and cooling capacity.

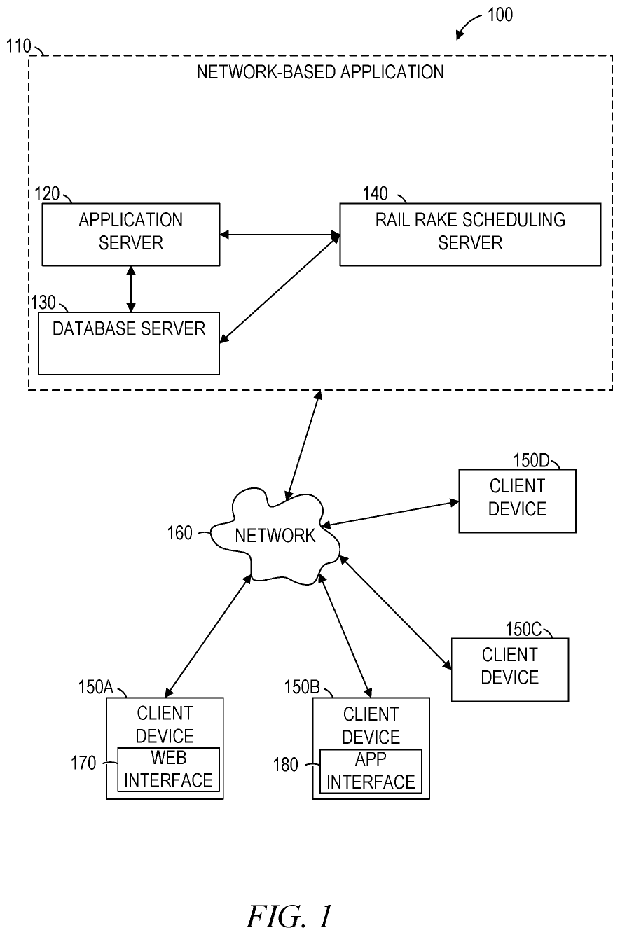

FIG. 1 is a network diagram illustrating an example network environment 100 suitable for rail rake planning for transportation and maintenance. The network environment 100 includes a network-based application 110, client devices 150A, 150B, 150C, and 150D, and a network 160. The network-based application 110 is provided by an application server 120 in communication with a database server 130 and a rail rake planning server 140. The application server 120 accesses application data (e.g., application data stored by the database server 130) to provide one or more applications to the client devices 150A-150D via a web interface 170 or an application interface 180.

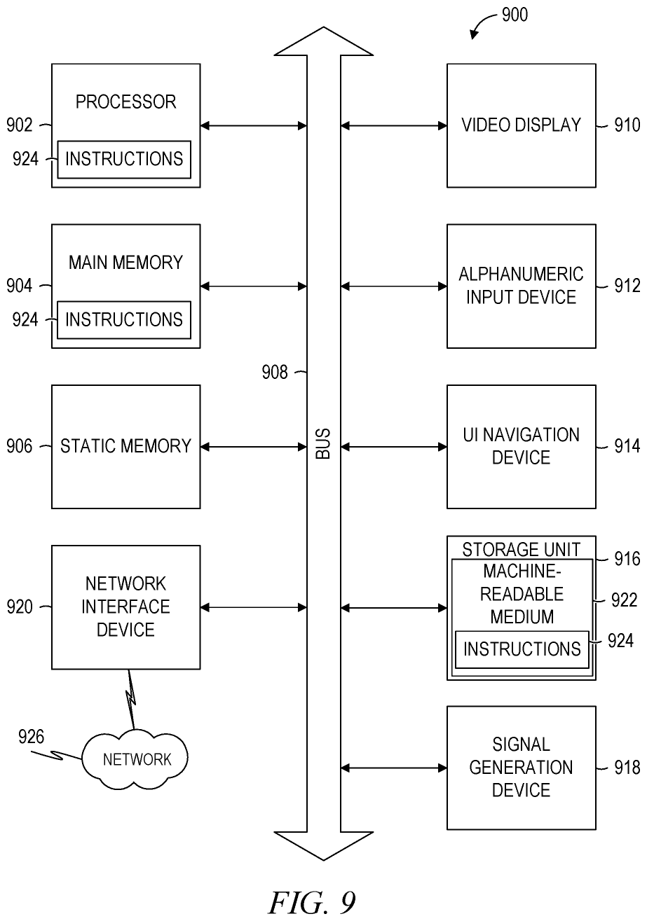

The application server 120, the database server 130, the rail rake planning server 140, and the client devices 150A-150D may each be implemented in a computer system, in whole or in part, as described below with respect to FIG. 9. The client devices 150A-150D may be referred to collectively as client devices 150 or generically as a client device 150.

The rail rake planning server 140 accesses data from the database server 130, the application server 120, or the client devices 150. For example, the application server 120 may cause a user interface to be presented on a client device 150 for entering data regarding rail rake availability, order information, maintenance scheduling data, optimization parameter values, or any suitable combination there. For example, the application server 120 may generate a hypertext markup language (HTML) page to be rendered by the web interface 170. The received data may be stored by the database server 130 for access by the rail rake planning server 140.

The rail rake planning server 140 determines, based on data from the database server 130, allocation of rail rakes to containers from orders to transport the containers between stations. The scheduling information is sent from the rail rake planning server 140 or the application server 120 to one or more of the client devices 150A-150D via the network 160. For example, emails, text messages, or push notifications may be sent to the client devices 150A-150D. Each of the client devices 150A-150D is associated with a different rail station. For example, the client devices 150 may be desktop computers located in offices of the rail stations. As another example, the client devices 150 may be mobile devices of managers of the rail stations. Based on the scheduling information received at a client device 150 associated with a rail station, the rail rakes are allocated to containers at the rail station and are dispatched to other rail stations.

Any of the machines, databases, or devices shown in FIG. 1 may be implemented in a general-purpose computer modified (e.g., configured or programmed) by software to be a special-purpose computer to perform the functions described herein for that machine, database, or device. For example, a computer system able to implement any one or more of the methodologies described herein is discussed below with respect to FIG. 9. As used herein, a “database” is a data storage resource and may store data structured as a text file, a table, a spreadsheet, a relational database (e.g., an object-relational database), a triple store, a hierarchical data store, a document-oriented NoSQL database, a file store, or any suitable combination thereof. The database may be an in-memory database. Moreover, any two or more of the machines, databases, or devices illustrated in FIG. 1 may be combined into a single machine, database, or device, and the functions described herein for any single machine, database, or device may be subdivided among multiple machines, databases, or devices.

The application server 120, the database server 130, the rail rake planning server 140, and the client devices 150A-150B are connected by the network 160. The network 160 may be any network that enables communication between or among machines, databases, and devices. Accordingly, the network 160 may be a wired network, a wireless network (e.g., a mobile or cellular network), or any suitable combination thereof. The network 160 may include one or more portions that constitute a private network, a public network (e.g., the Internet), or any suitable combination thereof.

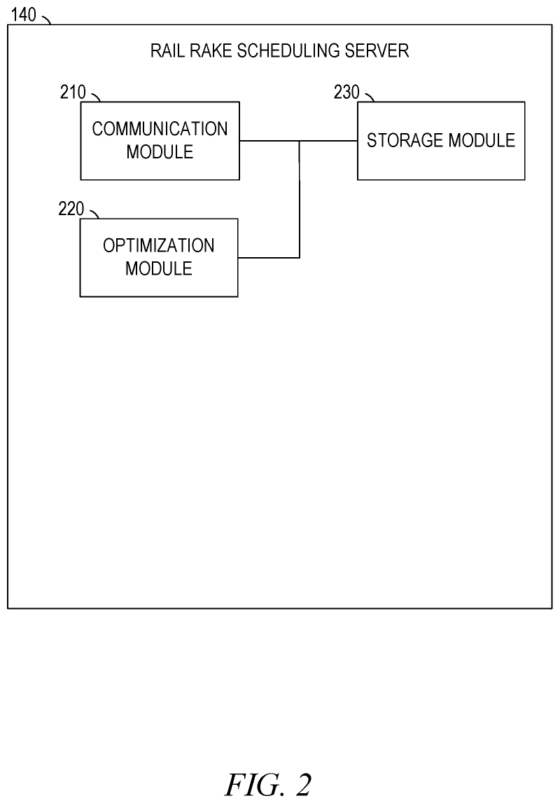

FIG. 2 is a block diagram of an example rail rake planning server 140 suitable for rail rake planning. The rail rake planning server 140 is shown as including a communication module 210, an optimization module 220, and a storage module 230, all configured to communicate with each other (e.g., via a bus, shared memory, or a switch). Any one or more of the modules described herein may be implemented using hardware (e.g., a processor of a machine). For example, any module described herein may be implemented by a processor configured to perform the operations described herein for that module. Moreover, any two or more of these modules may be combined into a single module, and the functions described herein for a single module may be subdivided among multiple modules. Furthermore, modules described herein as being implemented within a single machine, database, or device may be distributed across multiple machines, databases, or devices.

The communication module 210 receives data sent to the rail rake planning server 140 and transmits data from the rail rake planning server 140. For example, the communication module 210 may receive, from the application server 120, an identifier of one or more datasets to use for rail rake scheduling. Thus, the rail rake planning server 140 may perform rail rake scheduling for multiple rail networks (e.g., different national networks such as an Indian rail network and a rail network in the United States). As another example, the communication module 210 may receive, from the database server 130, rail rake, order, station, and parameter data for use by the optimization module 220 in performing rail rake scheduling. Communications sent and received by the communication module 210 may be intermediated by the network 160.

The optimization module 220 determines, based on rail rake, order, station, and parameter data, a schedule for the rail rakes. The scheduling may make use of an optimization algorithm that balances factors for revenue maximization, rake utilization, and delivery timeliness.

The datasets, scheduling results, or any suitable combination thereof may be stored and accessed by the storage module 230. For example, local storage of the rail rake planning server 140, such as a hard drive, may be used. As another example, network storage may be accessed by the storage module 230 via the network 160.

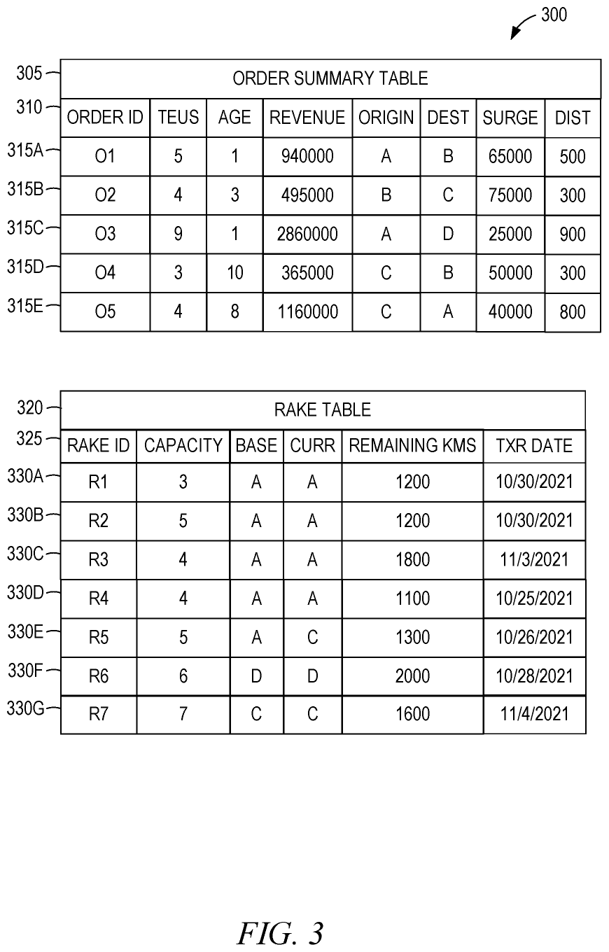

FIGS. 3-6 are block diagrams of an example database schema 300, suitable for use in rail rake planning. FIG. 3 includes an order summary table 305 and a rake table 320. The order summary table 305 includes rows 315A, 315B, 315C, 315D, and 315E of a format 310. The rake table 320 includes rows 330A, 330B, 330C, 330D, 330E, 330F, and 330G of a format 325. Data in the order summary table 305 may be received from a customer front-end that allows customers to request rail services by identifying origin and destination stations and a number of TEUs to be transported. Data in the rake table 320 may be received from rail rake providers and maintainers (e.g., updated by mechanics after each time maintenance work is performed).

As shown by the format 310, each row 315A-315E of the order summary table 305 includes data for a unique order identifier. The data for the order identifier includes a number of twenty-foot equivalents (TEUs) of containers to be shipped, an age of the order, a revenue for the order, an origin station for the order, a destination station for the order, surge pricing for the order, and a distance between the origin and destination stations. The age of the order may be measured in days since the order was received. Additionally or alternatively, a date on which the order was received may be stored in the order summary table 305 and the age calculated based on the stored date and a current date. The revenue for the order may be determined based on the number of TEUs and the origin and destination stations, such that all orders with the same number of TEUs and the same origin and destination stations have the same revenue value. Order-specific differentiation (e.g., based on contractual agreements, cargo value, prioritization fees, or any suitable combination thereof) may be reflected in the surge value. Thus, the total value for completing a shipment may be the sum of the revenue and surge values. In other examples, a single value is stored that reflects the total revenue for the order. The revenue and surge values may be stored in a local currency (e.g., rupees, dollars, yen, yuan, or any suitable combination thereof).

In some examples, the order summary table 305 includes a timestamp field that indicates the date/time that the order was placed, a delivery date field that indicates a delivery deadline for the order as specified by the customer, a customer identifier that identifies the customer, or any suitable combination thereof.

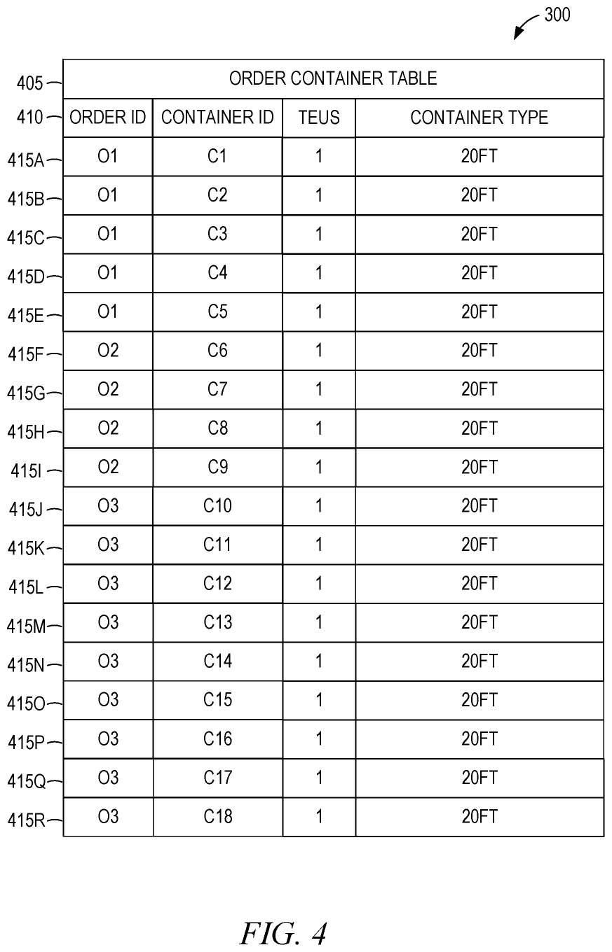

FIG. 4 includes an order container table 405 that includes rows 415A-415R in a format 410. The format 410 shows that each of the rows 415A-415R includes an order identifier, a container identifier, a container type, and a number of TEUs for each container in each order. The container identifier is a unique identifier for the container, the container type indicates the type of the container (e.g., 20 ft or 40 ft), the number of TEUs indicates the number of standard container units (e.g., one for 20 ft and two for 40 ft), and the order identifier indicates the order to which the container belongs (e.g., an order identifier from the order summary table 305).

The rake table 320 stores data for the rail rakes being scheduled. Each of the rows 330A-330G stores a unique rake identifier, a capacity (in TEUs) of the rake, a base station for the rake, a current station for the rake, a remaining distance the rake may travel before its next scheduled maintenance (measured in kilometers, in the example of FIG. 3), and a date of the next scheduled maintenance. The rail rake should return to its base station near the earlier of its next scheduled maintenance or travel of the scheduled distance. For example, after maintenance is performed, the next maintenance may be scheduled for 30 days or 3000 km later, whichever comes first.

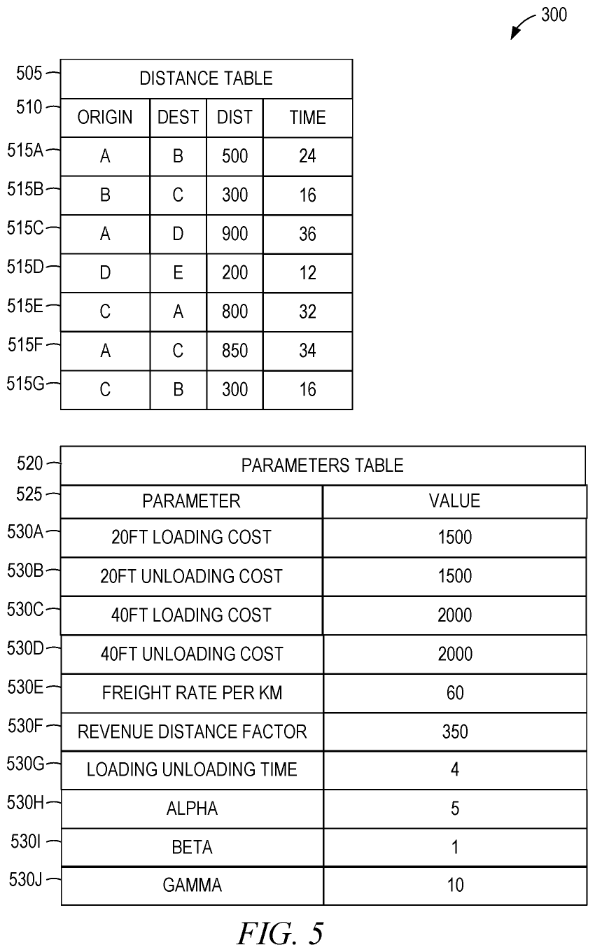

FIG. 5 includes a distance table 505 and a parameters table 520. The distance table 505 includes rows 515A, 515B, 515C, 515D, 515E, 515F, and 515G of a format 510. The parameters table 520 includes rows 530A, 530B, 530C, 530D, 530E, 530F, 530G, 530H, 530I, and 530J of a format 525. Data in the distance table 505 may be entered at the time of system creation, updated using distance-tracking devices installed on trains, or any suitable combination thereof. Data in the parameters table 520 may be controlled by an administrator of the rail rake planning server 140.

Each of the rows 515A-515G identifies an origin station, a destination station, a distance (e.g., in kilometers) between the origin and destination stations, and a travel time (e.g., in hours) between the origin and destination stations, as indicated by the format 510.

Parameters for the optimization of the rail rake planning may be stored in the parameters table 520. Each of the rows 530A-530J stores the name and value of one parameter. Parameters include loading and unloading costs (e.g., in rupees, dollars, or euros), travel costs per unit distance, revenue per unit distance, loading and unloading time (e.g., in hours), and weighting factors alpha, beta, and gamma. The weighting factors determine the relative importance of maximizing revenue, on-time delivery, and distributing usage across the rail rakes.

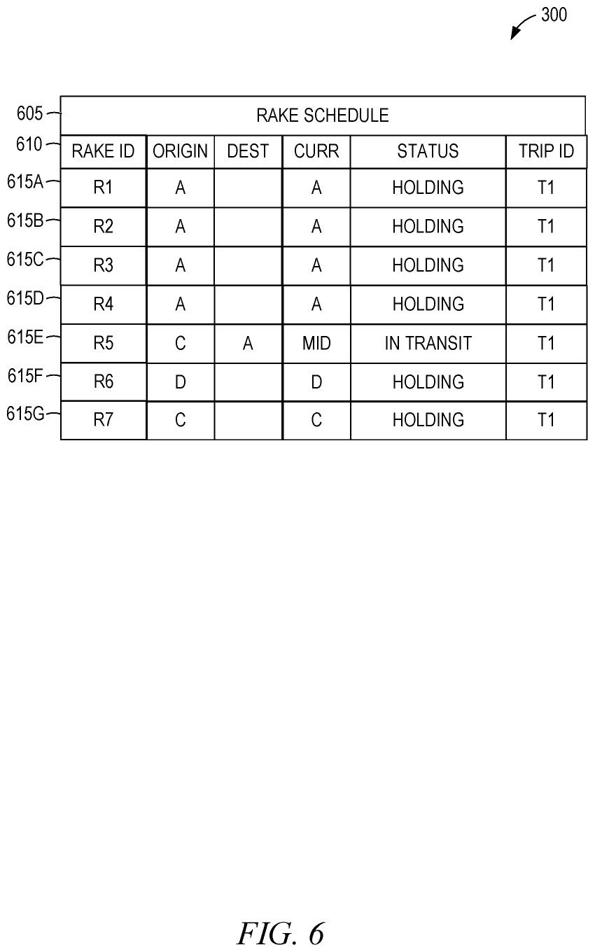

FIG. 6 includes a rake schedule table 605. The rake schedule table 605 includes rows 615A, 615B, 615C, 615D, 615E, 615F, and 615G of a format 610. The rake schedule table 605 may store output generated by the rail rake planning server 140 that was generated based on input data stored in the other tables of the schema 300.

Each of the rows 615A-615G stores information for a single trip for a single rail rake. The rake identifier and trip identifier for each row identify the unique rail rake/trip pair for the row. The row indicates an origin station and a destination station for the rail rake on the trip. Additionally, the row indicates a current location for the rail rake (e.g., at the origin station, at the destination station, or in transition between them) and a status (e.g., holding at a station or in transit between stations). Thus, in the example of FIG. 6, the row 615E indicates that rail rake R5, in trip T1, is currently in transit from station C to station A. The remaining rows 615A-615D and 615F-615G indicate that the other six rail rakes are holding at stations A, D, and C. The location of the rakes in the rake schedule table 605 may be updated in real-time based on global positioning system (GPS) sensors in the rakes or other sensor data.

Though the rake schedule table 605 is shown as including rows for a single trip identifier, the rail rake scheduling server may add data to the rake schedule table 605 for multiple trips. Thus, after arriving at station A, the rail rake R5 may be scheduled to perform a further delivery from station A to another station in a subsequent trip. Based on the data in the rake schedule table 605, communications may be sent to the client devices 150 to schedule the rail rakes.

In some examples, the rake schedule table 605 includes a rake status time that indicates a date/time when the status of the rake was last updated, a rake placement time that indicates the date/time at which the rake arrived at its current location, a source starting time that indicates the date/time at which the rake departed its origin if the rake is in transit, a standard arrival time that indicates the estimated arrival date/time at the destination if the rake is in transit, or any suitable combination thereof.

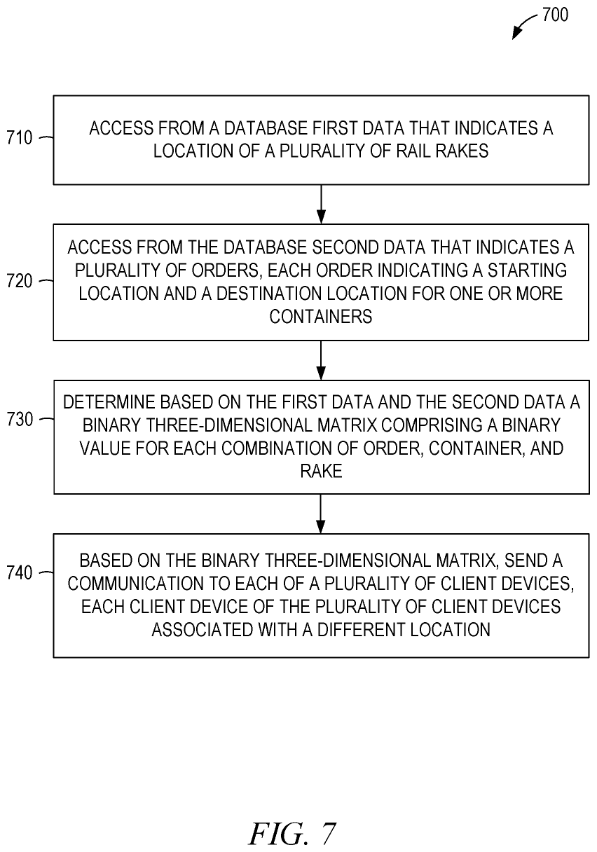

FIG. 7 is a flowchart illustrating operations of an example method 700 suitable for rail rake planning for transportation and maintenance. The method 700 includes operations 710, 720, 730, and 740. By way of example and not limitation, the method 700 is described as being performed by the rail rake planning server 140 of FIG. 1, using the modules of FIG. 2 and the database schema 300 of FIGS. 3-6.

In operation 710, the optimization module 220 accesses, from a database, first data that indicates a location of a plurality of rail rakes. For example, the rake table 320 may be accessed using the database server 130, with each row of the rake table 320 indicating a location of a rail rake.

The optimization module 220, in operation 720, accesses from the database second data that indicates a plurality of orders, each order indicating a starting location and a destination location for one or more containers. For example, the order summary table 305 may be accessed, including an origin column and a destination column.

Based on the first data and the second data, the optimization module 220 determines a binary three-dimensional matrix comprising a binary value for each combination of order, container, and rake (operation 730). An example algorithm to determine the binary three-dimensional matrix can be found by maximizing the value of

$${\sum }_{o = 1}^{{n}_{o}} {\sum }_{c = 1}^{{n}_{c , o}} {\sum }_{r = 1}^{{n}_{r}} α \cdot {y}_{o , c , r} \cdot {R}_{o , c} - β \cdot {\sum }_{o = 1}^{{n}_{o}} {p}_{o} \cdot \frac{1}{{n}_{c , o}} {\sum }_{c = 1}^{{n}_{c , o}} {\sum }_{r = 1}^{{n}_{r}} {y}_{o , c , r} \cdot \vert {ad}_{o , r} - e {d}_{o} \vert + γ {\sum }_{r = 1}^{{n}_{r}} \frac{1}{{rc}_{r}} {\sum }_{o = 1}^{{n}_{o}} {\sum }_{c = 1}^{{n}_{c , o}} {y}_{o , c , r} \qquad Equation 1$$

In equation 1, o, c, and r are the three dimensions of the binary three-dimensional matrix y. The value of y_{o,c,r} is 1 for combinations of order (o), container (c), and rail rake (r) that are served by the determined trip, and the value of y_{o,c,r} is 0 for all other elements of the matrix. R_{o,c} is the revenue for delivering container c of order o. n_{c,o} is the number of containers in order o. ad_{o,r} is the anticipated delivery time of rake r for order o (i.e., the date delivery is anticipated to occur if delivery is made in the currently planned trip). edₒ is the estimated delivery time of order o (e.g., the time specified for delivery in the order). rcᵣ is the capacity of rake r. nₒ is the total number of orders. nᵣ is the total number of rakes. pₒ is the priority parameter for order o. α is the weighting parameter for revenue maximization, β is the weighting parameter for delivery delay minimization, and γ is the weighting parameter for rake utilization maximization.

Thus, equation 1 includes three terms, one for revenue, one for delivery timeliness, and one for rail rake utilization. The three terms are weighted by the weighting parameters α, β and γ. By modifying the weighting parameters, the relative importance of revenue maximization, delivery delay minimization, and rake utilization maximization are modified. The revenue and rail rake utilization terms are positive, such that greater revenue and greater rail rake utilization are preferred. The delay term is negative, such that lower delay is preferred. Equation 1 can be simplified by combining like terms to generate equation 2, below.

$${\sum }_{o = 1}^{{n}_{o}} {\sum }_{c = 1}^{{n}_{c , o}} {\sum }_{r = 1}^{{n}_{r}} ( α \cdot {y}_{o , c , r} \cdot {R}_{o , c} - β \cdot {p}_{o} \cdot {y}_{o , c , r} \cdot \frac{\vert {ad}_{o , r} - {ed}_{o} \vert}{{n}_{c , o}} + γ \cdot \frac{{y}_{o , c , r}}{{rc}_{r}} ) \qquad Equation 2$$

The value of ad_{o,r} may be determined using equation 3, below.

ad_{o,r}=avd_{r,l}+lutₗ₌ₛ_{ₒ}+stₛ_{ₒ}_{,d}_{ₒ} Equation 3:

In equation 3, avd_{r,l} is the available date of rake r at location l. lutₗ₌ₛₒ is the average loading or unloading time at location l. st_{s,d} is the standard time of delivery from source s to destination d. sₒ is the source location of order o. dₒ is the destination location of order o.

Constraints on the solution are defined by rake availability (equation 4), rake capacity (equation 5), indivisibility of containers (equation 6), a rake maintenance schedule (equation 7), and indivisibility of orders (equation 8). Thus, by maximizing the value of equation 2, subject to the constraints of equations 4-8, the binary three-dimensional matrix y is determined.

y_{o,c,r}≤RP_{r,l=s}_{ₒ}∀o, c, r, sₒ Equation 4:

Σₒ₌₁ⁿ^{ₒ}Σ_{c=1}ⁿ^{_{c,o}}y_{o,c,r}≤rcᵣ∀r Equation 5:

Σᵣ₌₁ⁿ^{ᵣ}y_{o,c,r}≤1∀o, c Equation 6:

y_{o,c,r}·disₒ≤rdᵣ−mbdᵣ∀o, c, r Equation 7:

(Σ_{c=1}ⁿ^{_{c,o}}Σᵣ₌₁ⁿ^{ᵣ}y_{o,c,r})%n_{c,o}=0∀o Equation 8:

RP_{r,l} is =if rake r is placed at location l and 0 otherwise. disₒ is the travel distance for order o. rdᵣ is the remaining distance before maintenance of rake r. mbdᵣ is the maintenance buffer distance of rake r. % is the modulus operator.

The data used for the optimization equation may be accessed from the database schema 300 of FIGS. 3-6. For example, the weights α, β, and γ may be accessed from rows 530H-530J of the parameters table 520 of FIG. 5. The time lut and cost for loading and unloading containers may be accessed from the rows 530A-530D and 530F. The orders data may be accessed from the order summary table 305, comprising one entry for each order. As an intermediate step, the order container table 405 may be created (or data added to an existing table). The order container table 405 includes one row for each container in each order. Thus, with reference to the rows 315A-315E of FIG. 3, a total of twenty-five rows would be created, five for the five TEUs of order O1, four for order O2, nine for order O3, three for order O4, and four for order O5. For illustration purposes, only the rows for O1, O2, and O3 are shown in the order container table 405, but additional rows may be created. The order container table 405 may be accessed and used in the optimization process to determine the binary three-dimensional matrix.

Maintenance data may be accessed from the rake table 320 of FIG. 3 and used in the optimization process to determine the binary three-dimensional matrix. For example, for each of the rail rakes, a maintenance location may be accessed from the base column of the rake table 320 and a usage distance remaining rd may be accessed from the remaining kms column. Additionally, the rake table 320 may indicate additional data about the rail rakes that is used in determining the binary three-dimensional matrix, such as the number of containers rc each rake can carry (e.g., retrieved from the capacity column).

To handle maintenance scheduling, at the start of each trip, the location for each rake is checked to see if all orders originating from the location require greater travel distance than the remaining distance before maintenance of the rake. If so, the rake is added to a maintenance set. Rakes in the maintenance set may only be assigned to carry containers which have a destination the same as the base location of the rake, in some examples. Rakes in the maintenance set that are already at their base locations are not assigned any containers, in some examples.

Distance and transit time data for pairs of locations (e.g., port stations) may be accessed from the distance table 505 and used in determining dis as part of determining the binary three-dimensional matrix. Revenue data R for orders may be accessed from the order summary table (e.g., from the revenue column, from the surge column, or a combination thereof) and used in the optimization algorithm.

In operation 740, based on the binary three-dimensional matrix, the communication module 210 sends a communication to each of a plurality of client devices 150, each client device of the plurality of client devices associated with a different location. For example, emails, text messages, or push notifications may be sent to devices located in station offices or belonging to station managers. The station managers may act on the received messages to assign containers to rail rakes, to assign rail rakes to engines, to determine a sequence of orders to fulfill, or any suitable combination thereof. The communications may include the complete assignment of TEUs to rakes at all port stations or include only the assignment of TEUs to rakes at the station to which the communication is being sent.

Thus, by use of the method 700, station managers are enabled to coordinate their planning of servicing orders to improve efficiency of use of resources.

The revenue for each container may be determined using Algorithm 1, below.

Algorithm 1: Container-wise Revenue Calculation

| Result: | Ready-to-Access Revenue Model for each Individual Container for Optimization |
|---|---|
| | Framework |

Input:

| | |
|---|---|
| 1. | Number of Containers for each Order |
| 2. | Distance to be Covered for each Order Fulfilment |
| 3. | Revenue earned for each Order |
| 4. | Surge Pricing for each Order |
| 5. | Freight Rate |
| 6. | Container Loading Costs |
| 7. | Container Unloading Costs |

Initialize Dictionary Revenue[ ][ ]
for orderID ← all unique OrderIDs in FWO, do

| \| | for containerID ← all Containers in order ID, do | |
|---|---|---|
| \| | \| | |
| \| | \| | grossRevenue ← |

| | | |
|---|---|---|
| \| | \| | (Revenue[orderID] + SurgePricing[orderID])/numcontainers[orderID] |
| \| | \| | transportCost ← |
| \| | \| | laodingCost + (orderDistance[orderID] * freightRate) + unloadingCost |
| \| | \| | Revenue[orderID][containerID] = grossRevenue − transportCost |

| | |
|---|---|
| \| | \| |
| \| | end |

end
return Revenue

The initial rake placements and remaining distance values may be determined using Algorithm 2, below.

Algorithm 2: Initial Rake Positions

Result: Live Rake Placement Data to be maintained and updated after each Trip
Input:

| | |
|---|---|
| 1. | Rake Master Data |
| 2. | Rake Schedule |

```
Initialize DataFrame tempRakePlacements
tempRakePlacements[RakeID] ← all unique Rake IDs from Rake Master Data]
  tempRakePlacements[Remaining KMs] ← Rake Schedule
  for each unique RakeID in Rake Master do
```

| \| | if (Rake Schedule[Status] == ‘Awaiting Departure′), then | |
|---|---|---|
| \| | \| | |
| \| | \| | tempRakePlacements[Location] = Rake Schedule[Rake Status Location] |
| \| | \| | tempRakePlacements[PlacementTime] = Rake Schedule[Rake |
| \| | \| | Placement Time] |
| \| | \| | |
| \| | else if (Rake Schedule[Status] == ‘InTransit′), then | |
| \| | \| | |
| \| | \| | tempRakePlacements[Location] = Rake Schedule[Destination] |
| \| | \| | tempRakePlacements[Placement Time] = Rake Schedule[Standard |
| \| | \| | Arrival Time] |
| \| | \| | |
| \| | else if (Rake Schedule[Status] == ‘InMaintenance′), then | |
| \| | \| | |
| \| | \| | tempRakePlacements[Location] = Rake Master[Base Location] |
| \| | \| | tempRakePlacements[Placement Time] = Rake Schedule[Rake |
| \| | \| | Placement Time] |
| \| | \| | |
| \| | else | |
| \| | \| | |
| \| | \| | tempRakePlacements[Location] = Rake Master[Origin] |
| \| | \| | tempRakePlacements[Placement Time] = Rake Schedule[Rake |
| \| | \| | Placement Time] |

| | |
|---|---|
| \| | \| |
| \| | end |

end
return tempRakePlacements

Rake availability and actual delivery times may be determined using Algorithm 3, below.

Algorithm 3: Actual Delivery Datetimes for Order-Rake pairs

| Result: | Ready-to-Access Actual Delivery Times of each Order Paired with Available |
|---|---|
| | Rakes |

Input:

| | |
|---|---|
| 1. | FWO (Forwarding Orders) |
| 2. | Rake Master Data |
| 3. | Latest Temporary Rake Placements |
| 4. | Rake Loading/Unloading Time in Hours |
| 5. | Distance Matrix / Lanes Master Data |

Initialize Dictionary Actual Delivery[ ][ ]
for orderID ← all unique Order IDs in FWO, do

| \| | for rakeID ← all unique Rake IDs in Rake Master, do | |
|---|---|---|
| \| | \| | |
| \| | \| | rakeLocation ← tempRakePlacemenst[rakeID][Location] |

| | | |
|---|---|---|
| \| | \| | orderSource ← FWO[order ID][Origin] |
| \| | \| | orderDestination ← FWO[orderID][Destination] |

| \| | \| | |
|---|---|---|
| \| | \| | if (rakeLocation == orderSource), then |

| | | |
|---|---|---|
| \| | \| | \| |
| \| | \| | \| rakePlacementTime ← tempRakePlacemenst[rakeID][Placement |
| \| | \| | \| Time] travelTime ← Distance Matrix[orderSource][orderDestination] |
| \| | \| | \| ActualDelivery[orderID][rakeID] = |
| \| | \| | \| rakePlacementTime + loadingUnloadingTime + travelTime |
| \| | \| | \| |

| | | |
|---|---|---|
| \| | \| | else |

| | | |
|---|---|---|
| \| | \| | \| |
| \| | \| | \| ActualDelivery[orderID][rakeID] = null |
| \| | \| | \| |

| | | |
|---|---|---|
| \| | \| | end |

| | |
|---|---|
| \| | end |

end
return ActualDelivery

Order containers may be assigned to available rakes using Algorithm 4, below.

```
Algorithm 4: Trip-wise Optimal Assignments of Containers to Available Rakes
  while flag = = True do
  | Initialize Dictionary of Decision Variables Y_{o,c,r}
  | for order ID ← all Order IDS in Order List do
  | | for container ID ← all Container IDs in order ID do
  | | | for rakeID ← all Rake IDs in Rake List do
  | | | | if {(ActualDelivery[orderID][rakeID] is not null), and
  | | | | ((orderID, containerID) ∉ successful Assignments), and
  | | | | ((orderID, containerID) ∉ successful Assignments), and
  | | | | (rakeID ∉ in Maintenance)} then
  | | | | | Y_{orderID,containerID,rakeID} ← Binary Decision Variable for Linear
  | | | | | Optimization, such that Y_{o,c,r} ∈ {0, 1} ∀ o, c, r
  | | | end
  | | end
  | end
  | Define Optimization Objective :
  |  $Maximize \{ {\sum }_{o = 1}^{{n}_{o}} {\sum }_{c = 1}^{n {c}_{o}} {\sum }_{r = 1}^{{n}_{r}} ( α \cdot {Y}_{o , c , r} \cdot {Rev}_{o , c} - β \cdot {prior}_{o} \cdot {Y}_{o , c , r} \cdot \frac{\vert {actDel}_{o , r} - {expDel}_{o} \vert}{{numCont}_{o}} + γ \cdot \frac{{Y}_{o , c , r}}{{rakeCap}_{r}} ) \}$
  | Impose Linear Optimization Constraints :
  | 1. Rake Capacity
  |  ${\sum }_{o = 1}^{{n}_{o}} {\sum }_{c = 1}^{n {c}_{o}} {Y}_{o , c , r} <= {rakeCap}_{r} ∀ r$
  | 2. Each Container Assigned to at most One Container
  |  ${\sum }_{r = 1}^{{n}_{r}} {Y}_{o , c , r} <= 1 ∀ o , c$
  | 3. In Maintenance Rakes can only be Scheduled for Base Location
  | Y_{o,c,r} = 0 ∀o, c, r where (r ∈ inMaintenance) and (dest(o) ≠ baseLocation(r))
  | Solve for Optimal value of Y_{o,c,r}
  | for orderID ← all Order IDS in Order List do
  | | for container ID ← all Container IDs in order ID do
  | | | for rakeID ← all Rake IDs in Rake List do
  | | | | if (Y_{o,c,r} > 0) then
  | | | | | Assign to rakeID ← container ID of order ID
  | | | end
  | | end
  | end 4
  | Update current Rake Positions
  | tripCount ← tripCount + 1
  end
  return Optimal Assignments
```

In view of the above-described implementations of subject matter, this application discloses the following list of examples, wherein one feature of an example in isolation or more than one feature of an example, taken in combination and, optionally, in combination with one or more features of one or more further examples are further examples also falling within the disclosure of this application.

Example 1 is a method comprising: accessing, by one or more processors and from a database, first data that indicates a location of a plurality of rail rakes; accessing, by the one or more processors and from the database, second data that indicates a plurality of orders, each order indicating a starting location and a destination location for one or more containers; determining, by the one or more processors and based on the first data and the second data, a binary three-dimensional matrix comprising a binary value for each combination of order, container, and rake; and based on the binary three-dimensional matrix, sending a communication to each of a plurality of client devices, each client device of the plurality of client devices associated with a different location.

In Example 2, the subject matter of Example 1, wherein the determining of the binary three-dimensional matrix comprises: maximizing an evaluation function that comprises a first term for revenue, a second term for delivery timeliness, and a third term for rail rake utilization.

In Example 3, the subject matter of Example 2, wherein the first term is positive, the second term is negative, and the third term is positive.

In Example 4, the subject matter of Example 3 includes accessing third data that indicates a first weight for the first term, a second weight for the second term, and a third weight for the third term; wherein the determining of the binary three-dimensional matrix is further based on the third data.

In Example 5, the subject matter of Examples 1-4, wherein the sending of the communication to each of the plurality of client devices comprises sending an email to each of the plurality of client devices.

In Example 6, the subject matter of Examples 1-5, wherein: the second data that indicates the plurality of orders comprises one entry for each order of the plurality of orders; the method further comprises: generating, based on the second data, third data that comprises one entry for each container of each of the plurality of orders; and the determining of the binary three-dimensional matrix is further based on the third data.

In Example 7, the subject matter of Examples 1-6 includes accessing, by the one or more processors and from the database, third data that indicates, for each of the plurality of rail rakes, a maintenance location and a usage distance remaining until scheduled maintenance; wherein the determining of the binary three-dimensional matrix is further based on the third data.

In Example 8, the subject matter of Examples 1-7 includes accessing, by the one or more processors and from the database, third data that indicates, for each of the plurality of rail rakes, a container capacity; wherein the determining of the binary three-dimensional matrix is further based on the third data.

In Example 9, the subject matter of Examples 1-8 includes accessing, by the one or more processors and from the database, third data that indicates, for each of a plurality of location pairs, a distance and a travel time; wherein the determining of the binary three-dimensional matrix is further based on the third data.

In Example 10, the subject matter of Examples 1-9 includes accessing, by the one or more processors and from the database, third data that indicates, for each of the orders, a revenue; wherein the determining of the binary three-dimensional matrix is further based on the third data.

In Example 11, the subject matter of Examples 1-10 includes accessing, by the one or more processors and from the database, third data that indicates a container unloading time; wherein the determining of the binary three-dimensional matrix is further based on the third data.

Example 12 is a system comprising: a memory that stores instructions; and one or more processors configured by the instructions to perform operations comprising: accessing, from a database, first data that indicates a location of a plurality of rail rakes; accessing, from the database, second data that indicates a plurality of orders, each order indicating a starting location and a destination location for one or more containers; determining, based on the first data and the second data, a binary three-dimensional matrix comprising a binary value for each combination of order, container, and rake; and based on the binary three-dimensional matrix, sending a communication to each of a plurality of client devices, each client device of the plurality of client devices associated with a different location.

In Example 13, the subject matter of Example 12, wherein the determining of the binary three-dimensional matrix comprises: maximizing an evaluation function that comprises a first term for revenue, a second term for delivery timeliness, and a third term for rail rake utilization.

In Example 14, the subject matter of Example 13, wherein the first term is positive, the second term is negative, and the third term is positive.

In Example 15, the subject matter of Example 14 includes accessing third data that indicates a first weight for the first term, a second weight for the second term, and a third weight for the third term; wherein the determining of the binary three-dimensional matrix is further based on the third data.

In Example 16, the subject matter of Examples 12-15, wherein the sending of the communication to each of the plurality of client devices comprises sending an email to each of the plurality of client devices.

In Example 17, the subject matter of Examples 12-16, wherein: the second data that indicates the plurality of orders comprises one entry for each order of the plurality of orders; the operations further comprise: generating, based on the second data, third data that comprises one entry for each container of each of the plurality of orders; and the determining of the binary three-dimensional matrix is further based on the third data.

Example 18 is a non-transitory computer-readable medium that stores instructions that, when executed by one or more processors, cause the one or more processors to perform operations comprising: accessing, from a database, first data that indicates a location of a plurality of rail rakes; accessing, from the database, second data that indicates a plurality of orders, each order indicating a starting location and a destination location for one or more containers; determining, based on the first data and the second data, a binary three-dimensional matrix comprising a binary value for each combination of order, container, and rake; and based on the binary three-dimensional matrix, sending a communication to each of a plurality of client devices, each client device of the plurality of client devices associated with a different location.

In Example 19, the subject matter of Example 18, wherein the operations further comprise: accessing, from the database, third data that indicates, for each of the plurality of rail rakes, a maintenance location and a usage distance remaining until scheduled maintenance; wherein the determining of the binary three-dimensional matrix is further based on the third data.

In Example 20, the subject matter of Examples 18-19, wherein the operations further comprise: accessing, from the database, third data that indicates, for each of the plurality of rail rakes, a container capacity; wherein the determining of the binary three-dimensional matrix is further based on the third data.

Example 21 is at least one machine-readable medium including instructions that, when executed by processing circuitry, cause the processing circuitry to perform operations to implement any of Examples 1-20.

Example 22 is an apparatus comprising means to implement any of Examples 1-20.

Example 23 is a system to implement any of Examples 1-20.

Example 24 is a method to implement any of Examples 1-20.

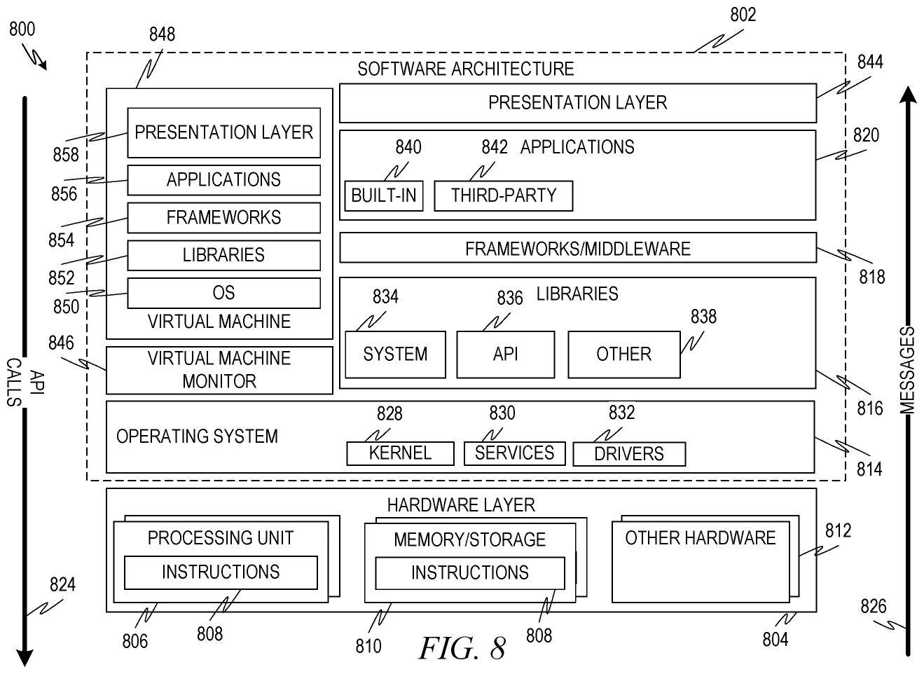

FIG. 8 is a block diagram 800 showing one example of a software architecture 802 for a computing device. The architecture 802 may be used in conjunction with various hardware architectures, for example, as described herein. FIG. 8 is merely a non-limiting example of a software architecture and many other architectures may be implemented to facilitate the functionality described herein. A representative hardware layer 804 is illustrated and can represent, for example, any of the above referenced computing devices. In some examples, the hardware layer 804 may be implemented according to the architecture of the computer system of FIG. 8.

The representative hardware layer 804 comprises one or more processing units 806 having associated executable instructions 808. Executable instructions 808 represent the executable instructions of the software architecture 802, including implementation of the methods, modules, subsystems, and components, and so forth described herein. The hardware layer 804 may also include memory and/or storage modules 810, which also have executable instructions 808. Hardware layer 804 may also comprise other hardware as indicated by other hardware 812, which represents any other hardware of the hardware layer 804, such as the other hardware illustrated as part of the software architecture 802.

In the example architecture of FIG. 8, the software architecture 802 may be conceptualized as a stack of layers where each layer provides particular functionality. For example, the software architecture 802 may include layers such as an operating system 814, libraries 816, frameworks/middleware 818, applications 820, and presentation layer 844. Operationally, the applications 820 and/or other components within the layers may invoke application programming interface (API) calls 824 through the software stack and access a response, returned values, and so forth illustrated as messages 826 in response to the API calls 824. The layers illustrated are representative in nature and not all software architectures have all layers. For example, some mobile or special purpose operating systems may not provide a frameworks/middleware 818 layer, while others may provide such a layer. Other software architectures may include additional or different layers.

The operating system 814 may manage hardware resources and provide common services. The operating system 814 may include, for example, a kernel 828, services 830, and drivers 832. The kernel 828 may act as an abstraction layer between the hardware and the other software layers. For example, the kernel 828 may be responsible for memory management, processor management (e.g., scheduling), component management, networking, security settings, and so on. The services 830 may provide other common services for the other software layers. In some examples, the services 830 include an interrupt service. The interrupt service may detect the receipt of an interrupt and, in response, cause the architecture 802 to pause its current processing and execute an interrupt service routine (ISR) when an interrupt is accessed.

The drivers 832 may be responsible for controlling or interfacing with the underlying hardware. For instance, the drivers 832 may include display drivers, camera drivers, Bluetooth® drivers, flash memory drivers, serial communication drivers (e.g., Universal Serial Bus (USB) drivers), Wi-Fi® drivers, near-field communication (NFC) drivers, audio drivers, power management drivers, and so forth depending on the hardware configuration.

The libraries 816 may provide a common infrastructure that may be utilized by the applications 820 and/or other components and/or layers. The libraries 816 typically provide functionality that allows other software modules to perform tasks in an easier fashion than to interface directly with the underlying operating system 814 functionality (e.g., kernel 828, services 830 and/or drivers 832). The libraries 816 may include system libraries 834 (e.g., C standard library) that may provide functions such as memory allocation functions, string manipulation functions, mathematic functions, and the like. In addition, the libraries 816 may include API libraries 836 such as media libraries (e.g., libraries to support presentation and manipulation of various media format such as MPEG4, H.264, MP3, AAC, AMR, JPG, PNG), graphics libraries (e.g., an OpenGL framework that may be used to render two-dimensional and three-dimensional in a graphic content on a display), database libraries (e.g., SQLite that may provide various relational database functions), web libraries (e.g., WebKit that may provide web browsing functionality), and the like. The libraries 816 may also include a wide variety of other libraries 838 to provide many other APIs to the applications 820 and other software components/modules.

The frameworks/middleware 818 may provide a higher-level common infrastructure that may be utilized by the applications 820 and/or other software components/modules. For example, the frameworks/middleware 818 may provide various graphical user interface (GUI) functions, high-level resource management, high-level location services, and so forth. The frameworks/middleware 818 may provide a broad spectrum of other APIs that may be utilized by the applications 820 and/or other software components/modules, some of which may be specific to a particular operating system or platform.

The applications 820 include built-in applications 840 and/or third-party applications 842. Examples of representative built-in applications 840 may include, but are not limited to, a contacts application, a browser application, a book reader application, a location application, a media application, a messaging application, and/or a game application. Third-party applications 842 may include any of the built-in applications as well as a broad assortment of other applications. In a specific example, the third-party application 842 (e.g., an application developed using the Android™ or iOS™ software development kit (SDK) by an entity other than the vendor of the particular platform) may be mobile software running on a mobile operating system such as iOS™, Android™, Windows® Phone, or other mobile computing device operating systems. In this example, the third-party application 842 may invoke the API calls 824 provided by the mobile operating system such as operating system 814 to facilitate functionality described herein.

The applications 820 may utilize built in operating system functions (e.g., kernel 828, services 830 and/or drivers 832), libraries (e.g., system libraries 834, API libraries 836, and other libraries 838), frameworks/middleware 818 to create user interfaces to interact with users of the system. Alternatively, or additionally, in some systems, interactions with a user may occur through a presentation layer, such as presentation layer 844. In these systems, the application/module “logic” can be separated from the aspects of the application/module that interact with a user.

Some software architectures utilize virtual machines. In the example of FIG. 8, this is illustrated by virtual machine 848. A virtual machine creates a software environment where applications/modules can execute as if they were executing on a hardware computing device. A virtual machine is hosted by a host operating system (operating system 814) and typically, although not always, has a virtual machine monitor 846, which manages the operation of the virtual machine 848 as well as the interface with the host operating system (i.e., operating system 814). A software architecture executes within the virtual machine 848 such as an operating system 850, libraries 852, frameworks/middleware 854, applications 856, and/or presentation layer 858. These layers of software architecture executing within the virtual machine 848 can be the same as corresponding layers previously described or may be different.

### Modules, Components and Logic

A computer system may include logic, components, modules, mechanisms, or any suitable combination thereof. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. One or more computer systems (e.g., a standalone, client, or server computer system) or one or more hardware processors may be configured by software (e.g., an application or application portion) as a hardware-implemented module that operates to perform certain operations as described herein.

A hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or another programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired), or temporarily or transitorily configured (e.g., programmed) to operate in a certain manner and/or to perform certain operations described herein. Hardware-implemented modules may be temporarily configured (e.g., programmed), and each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses that connect the hardware-implemented modules). Multiple hardware-implemented modules are configured or instantiated at different times. Communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. The processor or processors may be located in a single location (e.g., within a home environment, an office environment, or a server farm), or the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., APIs).

### Electronic Apparatus and System

The systems and methods described herein may be implemented using digital electronic circuitry, computer hardware, firmware, software, a computer program product (e.g., a computer program tangibly embodied in an information carrier, e.g., in a machine-readable medium for execution by, or to control the operation of, data processing apparatus, e.g., a programmable processor, a computer, or multiple computers), or any suitable combination thereof.

A computer program can be written in any form of programming language, including compiled or interpreted languages, and it can be deployed in any form, including as a standalone program or as a module, subroutine, or other unit suitable for use in a computing environment. A computer program can be deployed to be executed on one computer or on multiple computers at one site or distributed across multiple sites (e.g., cloud computing) and interconnected by a communication network. In cloud computing, the server-side functionality may be distributed across multiple computers connected by a network. Load balancers are used to distribute work between the multiple computers. Thus, a cloud computing environment performing a method is a system comprising the multiple processors of the multiple computers tasked with performing the operations of the method.

Operations may be performed by one or more programmable processors executing a computer program to perform functions by operating on input data and generating output. Method operations can also be performed by, and apparatus of systems may be implemented as, special purpose logic circuitry, e.g., an FPGA or an ASIC.

The computing system can include clients and servers. A client and server are generally remote from each other and typically interact through a communication network. The relationship of client and server arises by virtue of computer programs running on the respective computers and having a client-server relationship to each other. A programmable computing system may be deployed using hardware architecture, software architecture, or both. Specifically, it will be appreciated that the choice of whether to implement certain functionality in permanently configured hardware (e.g., an ASIC), in temporarily configured hardware (e.g., a combination of software and a programmable processor), or in a combination of permanently and temporarily configured hardware may be a design choice. Below are set out example hardware (e.g., machine) and software architectures that may be deployed.

### Example Machine Architecture and Machine-Readable Medium

FIG. 9 is a block diagram of a machine in the example form of a computer system 900 within which instructions 924 may be executed for causing the machine to perform any one or more of the methodologies discussed herein. The machine may operate as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch, or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 900 includes a processor 902 (e.g., a central processing unit (CPU), a graphics processing unit (GPU), or both), a main memory 904, and a static memory 906, which communicate with each other via a bus 908. The computer system 900 may further include a video display unit 910 (e.g., a liquid crystal display (LCD) or a cathode ray tube (CRT)). The computer system 900 also includes an alphanumeric input device 912 (e.g., a keyboard or a touch-sensitive display screen), a user interface navigation (or cursor control) device 914 (e.g., a mouse), a storage unit 916, a signal generation device 918 (e.g., a speaker), and a network interface device 920.

### Machine-Readable Medium

The storage unit 916 includes a machine-readable medium 922 on which is stored one or more sets of data structures and instructions 924 (e.g., software) embodying or utilized by any one or more of the methodologies or functions described herein. The instructions 924 may also reside, completely or at least partially, within the main memory 904 and/or within the processor 902 during execution thereof by the computer system 900, with the main memory 904 and the processor 902 also constituting machine-readable media 922.

While the machine-readable medium 922 is shown in FIG. 9 to be a single medium, the term “machine-readable medium” may include a single medium or multiple media (e.g., a centralized or distributed database, and/or associated caches and servers) that store the one or more instructions 924 or data structures. The term “machine-readable medium” shall also be taken to include any tangible medium that is capable of storing, encoding, or carrying instructions 924 for execution by the machine and that cause the machine to perform any one or more of the methodologies of the present disclosure, or that is capable of storing, encoding, or carrying data structures utilized by or associated with such instructions 924. The term “machine-readable medium” shall accordingly be taken to include, but not be limited to, solid-state memories, and optical and magnetic media. Specific examples of machine-readable media 922 include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and compact disc read-only memory (CD-ROM) and digital versatile disc read-only memory (DVD-ROM) disks. A machine-readable medium is not a transmission medium.

### Transmission Medium

The instructions 924 may further be transmitted or received over a communications network 926 using a transmission medium. The instructions 924 may be transmitted using the network interface device 920 and any one of a number of well-known transfer protocols (e.g., hypertext transport protocol (HTTP)). Examples of communication networks include a local area network (LAN), a wide area network (WAN), the Internet, mobile telephone networks, plain old telephone (POTS) networks, and wireless data networks (e.g., WiFi and WiMax networks). The term “transmission medium” shall be taken to include any intangible medium that is capable of storing, encoding, or carrying instructions 924 for execution by the machine, and includes digital or analog communications signals or other intangible media to facilitate communication of such software.

Although specific examples are described herein, it will be evident that various modifications and changes may be made to these examples without departing from the broader spirit and scope of the disclosure. Accordingly, the specification and drawings are to be regarded in an illustrative rather than a restrictive sense. The accompanying drawings that form a part hereof show by way of illustration, and not of limitation, specific examples in which the subject matter may be practiced. The examples illustrated are described in sufficient detail to enable those skilled in the art to practice the teachings disclosed herein.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” and “an” are herein used, as is common in patent documents, to include one or more than one instance. Finally, as used herein, the conjunction “or” refers to a non-exclusive “or,” unless specifically stated otherwise.

What is claimed is:

1. A method comprising:
accessing, by one or more processors and from a database, first data that indicates a location of a plurality of rail rakes;
accessing, by the one or more processors and from the database, second data that indicates a plurality of orders, each order indicating a starting location and a destination location for one or more containers;
determining, by the one or more processors and based on the first data and the second data, a binary three-dimensional matrix comprising a binary value for each combination of order, container, and rake; and
based on the binary three-dimensional matrix, sending a communication to each of a plurality of client devices, each client device of the plurality of client devices associated with a different location.

2. The method of claim 1, wherein the determining of the binary three-dimensional matrix comprises:
maximizing an evaluation function that comprises a first term for revenue, a second term for delivery timeliness, and a third term for rail rake utilization.

3. The method of claim 2, wherein the first term is positive, the second term is negative, and the third term is positive.

4. The method of claim 3, further comprising:
accessing third data that indicates a first weight for the first term, a second weight for the second term, and a third weight for the third term;
wherein the determining of the binary three-dimensional matrix is further based on the third data.

5. The method of claim 1, wherein the sending of the communication to each of the plurality of client devices comprises sending an email to each of the plurality of client devices.

6. The method of claim 1, wherein:
the second data that indicates the plurality of orders comprises one entry for each order of the plurality of orders;
the method further comprises:
generating, based on the second data, third data that comprises one entry for each container of each of the plurality of orders; and
the determining of the binary three-dimensional matrix is further based on the third data.

7. The method of claim 1, further comprising:
accessing, by the one or more processors and from the database, third data that indicates, for each of the plurality of rail rakes, a maintenance location and a usage distance remaining until scheduled maintenance;
wherein the determining of the binary three-dimensional matrix is further based on the third data.

8. The method of claim 1, further comprising:
accessing, by the one or more processors and from the database, third data that indicates, for each of the plurality of rail rakes, a container capacity;
wherein the determining of the binary three-dimensional matrix is further based on the third data.

9. The method of claim 1, further comprising:
accessing, by the one or more processors and from the database, third data that indicates, for each of a plurality of location pairs, a distance and a travel time;
wherein the determining of the binary three-dimensional matrix is further based on the third data.

10. The method of claim 1, further comprising:
accessing, by the one or more processors and from the database, third data that indicates, for each of the orders, a revenue;
wherein the determining of the binary three-dimensional matrix is further based on the third data.

11. The method of claim 1, further comprising:
accessing, by the one or more processors and from the database, third data that indicates a container unloading time;
wherein the determining of the binary three-dimensional matrix is further based on the third data.

12. A system comprising:
a memory that stores instructions; and
one or more processors configured by the instructions to perform operations comprising:
accessing, from a database, first data that indicates a location of a plurality of rail rakes;
accessing, from the database, second data that indicates a plurality of orders, each order indicating a starting location and a destination location for one or more containers;
determining, based on the first data and the second data, a binary three-dimensional matrix comprising a binary value for each combination of order, container, and rake; and
based on the binary three-dimensional matrix, sending a communication to each of a plurality of client devices, each client device of the plurality of client devices associated with a different location.

13. The system of claim 12, wherein the determining of the binary three-dimensional matrix comprises:
maximizing an evaluation function that comprises a first term for revenue, a second term for delivery timeliness, and a third term for rail rake utilization.

14. The system of claim 13, wherein the first term is positive, the second term is negative, and the third term is positive.

15. The system of claim 14, further comprising:
accessing third data that indicates a first weight for the first term, a second weight for the second term, and a third weight for the third term;
wherein the determining of the binary three-dimensional matrix is further based on the third data.

16. The system of claim 12, wherein the sending of the communication to each of the plurality of client devices comprises sending an email to each of the plurality of client devices.

17. The system of claim 12, wherein:
the second data that indicates the plurality of orders comprises one entry for each order of the plurality of orders;
the operations further comprise:
generating, based on the second data, third data that comprises one entry for each container of each of the plurality of orders; and
the determining of the binary three-dimensional matrix is further based on the third data.

18. A non-transitory computer-readable medium that stores instructions that, when executed by one or more processors, cause the one or more processors to perform operations comprising:
accessing, from a database, first data that indicates a location of a plurality of rail rakes;
accessing, from the database, second data that indicates a plurality of orders, each order indicating a starting location and a destination location for one or more containers;
determining, based on the first data and the second data, a binary three-dimensional matrix comprising a binary value for each combination of order, container, and rake; and
based on the binary three-dimensional matrix, sending a communication to each of a plurality of client devices, each client device of the plurality of client devices associated with a different location.

19. The non-transitory computer-readable medium of claim 18, wherein the operations further comprise:
accessing, from the database, third data that indicates, for each of the plurality of rail rakes, a maintenance location and a usage distance remaining until scheduled maintenance;
wherein the determining of the binary three-dimensional matrix is further based on the third data.

20. The non-transitory computer-readable medium of claim 18, wherein the operations further comprise:
accessing, from the database, third data that indicates, for each of the plurality of rail rakes, a container capacity;
wherein the determining of the binary three-dimensional matrix is further based on the third data.
